(19) United States
(12) Patent Application Publication
(10) Pub. No.: US 2026/0007298 A1
(43) Pub. Date: Jan. 8, 2026

(54) CLEANING IMPLEMENT AND METHOD OF PRODUCING THE CLEANING IMPLEMENT

(71) Applicant: Hayco Manufacturing Ltd., Hong Kong (CN)

(72) Inventors: Sven ESCHRICH, Berglen (DE); Piercy YAU, Hong Kong (CN)

(21) Appl. No.: 19/262,870

(22) Filed: Jul. 8, 2025

Related U.S. Application Data
(60) Provisional application No. 63/668,523, filed on Jul. 8, 2024.

(51) Int. Cl. A47L 13/254; A47L 13/42; B25G 3/38

(52) U.S. Cl. CPC A47L 13/254; A47L 13/42; B25G 3/38

(57) ABSTRACT

A cleaning implement, especially a mop, contains a mop head having a base and a pad attached to the base. The mop head is adapted and configured to be provided with a cleaning sheet or a cleaning pad. The base is made of at least one first plastic material, wherein the pad is made of at least one second plastic material which is suitable to be connected to the at least one first plastic material of the base by plastic welding or by adhesive bonding. The base and the pad are connected to each other by plastic welding or by adhesive bonding to form a composite mop head. The cleaning implement can be formed with an integrated spring clip for connecting two segments of a handle which is attached to the mop head. A method produces the cleaning implement.

### CROSS-REFERENCE TO RELATED APPLICATION

This application claims the benefit, under 35 U.S.C. § 119 (e), of provisional patent application No. 63/668,523, filed Jul. 8, 2024; the prior application is herewith incorporated by reference in its entirety.

### FIELD AND BACKGROUND OF THE INVENTION

The invention refers to a cleaning implement, especially to a mop, and to a method for producing the cleaning implement.

Cleaning tools or cleaning implements, such as mops, are widely recognized for their role in maintaining cleanliness. A typical mop contains several components, including a mop head responsible for holding the cleaning sheets and/or cleaning pads, and a handle, often composed of multiple segments for enhanced maneuverability and storage convenience. The efficacy of these cleaning implements often hinges on electrostatic charging, which occurs primarily at the mop head respectively the cleaning sheets/pads, aiding in the attraction and efficient removal of dust, hair, and other debris from surfaces while preventing their dispersion.

The mop head is one of the central elements and is used to securely attach the cleaning sheets/pads. Typically, the mop head consists of a base, commonly made from PP (polypropylene), and an associated elastic pad, typically made of EVA (ethylene-vinyl acetate). The elastic pad is affixed to the base through adhesive bonding, employing a suitable adhesive for a durable and stable connection, ensuring longevity during usage. Furthermore, the handle of the mop plays an important role in enabling users to manipulate and control the cleaning tool. Often, the handle includes multiple segments interconnected to allow for adjustable length, catering to individual preferences and needs. This feature not only enhances usability but also facilitates the storage of the mop. The handle segments are linked using spring clips, distinct components inserted into the ends of each segment. However, the utilization of a diverse array of materials and components renders the manufacturing process relatively costly and complicates recycling efforts.

### SUMMARY OF THE INVENTION

Thus, the invention aims to reduce the aforementioned drawbacks by providing an improved cleaning implement while also proposing a method for its efficient production.

This object is solved by means of the independent claims. Preferred embodiments are claimed with the subclaims.

The invention refers to a cleaning implement, especially to a mop, containing a mop head having a base and a pad attached to the base, the mop head being adapted and configured to be provided with a cleaning sheet or a cleaning pad, wherein the base is made of at least one first plastic material, and wherein the pad is made of at least one second plastic material which is suitable to be joined to the at least one first plastic material of the base by plastic welding, preferably by thermal welding. The base and the pad are joined together by plastic welding, preferably by thermal welding, to form a composite mop head.

The advantages of a mop head produced in this way is that there is no need to use an additional adhesive to bond the base and the pad, meaning that the mod head is not contaminated by the adhesive and is therefore completely recyclable. This complete recycling means, for example, that the mop head can be shredded and the shredded material can be reused as pure or essentially pure plastic. This also saves the use of an additional material, namely the adhesive. This contributes significantly to making the manufacturing process more cost-effective and the product more environmentally friendly.

Plastic welding in the sense of the present invention is understood to mean all joining processes in which two plastics are joined together by melting or fusing. In the case of the present invention, melting or fusing by means of plastic welding is in particular and especially preferably thermal welding. Alternatively, however, ultrasonic welding, laser welding, induction welding and vibration welding could also be used as plastic welding processes. A plastic welding process is also particularly preferred, preferably a thermal welding process, in which the two plastic materials or plastic components are fused or joined together without any additional materials or filler materials.

Thermal welding is specifically a process in which two plastic parts are joined together using heat. To do this, the plastic parts to be joined are first carefully cleaned and prepared to remove dirt, grease and other impurities that could affect the quality of the weld. The parts to be joined are then heated, for example by contact with a hot plate, a heating element or a hot gas flame. The temperature must be high enough to soften the plastic parts at the contact points without burning them. Once the plastic parts have reached the right temperature, they are pressed together to create a firm bond. The joined parts are then slowly cooled, essentially maintaining the pressure to ensure a stable weld. Thermal welding works best between plastic materials that have similar chemical properties or at least compatible melting points.

Ultrasonic welding, on the other hand, is not a thermal welding process as it does not rely on heat to join the plastic parts together. Instead, it uses high-frequency mechanical vibrations (ultrasound) to generate frictional heat that softens the plastic surfaces and forms a strong bond. Laser welding uses a laser beam to heat and melt the plastic surfaces, creating a permanent bond. Induction welding, on the other hand, uses electromagnetic induction to heat and weld the plastic surfaces.

With the plastic welding processes mentioned above, reliable connections between the base and the pad can be achieved without the use of adhesives.

A particularly preferred embodiment is one in which the second plastic material has elastic properties and, accordingly, the pad is an elastic pad. The design of the pad as an elastic pad serves to ensure even pressure distribution and stability during cleaning work. It also supports the movement of the mop across the floor and ensures that the associated cleaning sheet or cleaning pad remains in effective contact with the surface to remove dirt.

Particularly in connection with thermal welding as the preferred plastic welding process, it is preferable that the first plastic material and the second plastic material are formed by different but similar plastic materials. For example, the first plastic material and the second plastic material can each be thermoplastic plastic materials. As the inventor's experiments have shown, it is particularly advantageous if the first plastic material is polypropylene (PP) and/or if the second plastic material is expanded polypropylene (EPP). The term “expanded” refers specifically to the fact that the polypropylene is expanded during the manufacturing process to create a foamed structure. This foamed structure consists of many small air bubbles trapped in the polypropylene, which gives the material the desired elastic properties. It is therefore able to deform and compress under load, but returns to its original shape when the load is removed.

According to another particularly preferred embodiment, it is provided that the base is formed plate-shaped with a base top surface and with a base bottom surface and/or that the pad is formed plate-shaped with a pad top surface and with a pad bottom surface. This makes it possible to construct a mop head that is particularly suitable for cleaning tasks. In addition, such geometries make it easy to connect the base to the pad. This also applies to a particularly preferred embodiment in which the mop head has a rectangular circumferential geometry.

It is also preferred if the mop head has a leading edge and a trailing edge. In connection with such a structure, it is further particularly preferred when the leading edge and the trailing edge of the mop head are formed as part of the pad, preferably in such a way that the pad is drawn around the respective associated base edge at the leading edge and at the trailing edge and is plastic-welded, in particular thermally welded, on the base top surface. The term “leading edge” is intended to refer to the furthest edge of the mop head which leads the mop head when it is moved in a forward direction away from its user, whereas the term “trailing edge” is intended to refer to the furthest edge of the mop head which trails the mop head when it is moved in forward direction away from its user. For mops being used as floor mops, the leading edge and the trailing edge are substantially parallel to the longitudinal axis of the mop head, wherein the longitudinal axis is the axis along the length of the mop head.

Furthermore, it is particularly preferable if the base bottom surface is at least partially, preferably completely, covered by the pad and is at least partially plastic-welded, in particular thermally welded, to the pad top surface. This not only results in a functionally reliable connection between the pad and the base, but also ensures that the entire underside of the mop head has elastic properties, especially in conjunction with an elastic pad.

A design in which the pad bottom surface supports a cleaning sheet or a cleaning pad when it is attached to the mop head is also preferred. This allows cleaning tasks to be carried out safely and reliably, regardless of whether dry sheets or wet sheets are involved.

For securing the cleaning sheet or cleaning pad to the mop head, it is particularly preferred if the base top surface contains at least one, preferably several, securing elements configured to receive and retain a cleaning sheet or cleaning pad about the mop head. It is particularly preferred if the at least one securing element is formed by a separate component which is detachably held, preferably contour-matched and/or surface-flush detachably held, in a receiving opening formed on the base top surface. Such a detachable holder has the advantage that the securing elements can be easily removed from the mop head, as they are not usually made of the same material as the rest of the mop head. This means that the securing elements can be disposed of and recycled separately.

According to a further particularly preferred specific embodiment, it is provided that the cleaning implement further contains a handle pivotably connected to the mop head, preferably connected to the mop head by means of a universal joint attached to the base top surface. The universal joint preferably contains several, for example two, rotational axes that allow the handle to pivot in different directions. The pivotable linkage or, in particular, the universal joint results in the greatest possible freedom of movement of the mop head in different directions and angular positions. This makes it easier, for example, to maneuver the mop around corners and reach hard-to-reach areas more easily, which improves the overall cleaning performance.

In principle, the handle can be provided as a unitary structure. However, it is preferred when the handle contains at least two, preferably at least three, interconnectable segments that are detachably connected to each other in a connection section. This ensures that the cleaning implement can be shipped within a carton of convenience size and later assembled for use.

Irrespective of the specific number of segments, a particularly preferred embodiment provides that there are always two interconnectable segments defining a first segment and a second segment, the first segment having a tapered end which is configured to engage with a non-tapered end of the second segment, the first segment and the second segment being releasably connected in the joined state by means of a resilient spring clip. This allows the individual segments to be assembled and disassembled quickly and easily. The resilient spring clip enables simple and intuitive fixing, although it is of course also possible to connect the individual segments to each other in different ways, for example using threads so that the individual segments can be screwed together.

According to a further preferred embodiment, it is advantageous if the segments found in the middle of the handle comprise a tapered end and a non-tapered end, and wherein the end segment used to attach the handle to the mop head and the end segment containing or building a hand grip have at least a tapered end or a non-tapered end so as to interconnect with the segments in the middle of the handle. This not only ensures a functionally reliable structure, but also reliably prevents incorrect installation.

According to another particularly preferred embodiment, the spring clip is an integral part of the connection section formed by a tapered end of a first segment, which is preferably hollow. The integrated spring clip is formed by a snap-in segment, preferably by a snap-in segment cut free and/or connected on one side in the area of the tapered end, which is elastically pretensioned in the direction of latching engagement. As a result, in the latched state it engages overpressably in a correspondingly assigned opening at the hollow non-tapered end of an assigned second segment. Such an integrated spring clip offers the advantage that-unlike spring clips, which are formed by separate components-a reduction in the number of the component takes place without any loss of quality or function. Depending on the design of the segments, all spring clips can be configured as integrated spring clips. Alternatively, it is also possible to design only some of the spring clips as integrated spring clips or, in principle, it is of course also still possible to provide spring clips formed by separate components instead of the integrated spring clips. However, a particularly preferred embodiment in connection with the present inventive idea is an embodiment according to which at least a part of the spring clips is formed by integrated spring clips.

According to a further preferred embodiment, it is provided that at least part of the segments, preferably at least the end segment used to attach the handle to the mop head and/or at least the end segment containing or building a hand grip, at least in the connection section to an adjoining segment, but preferably completely, is made of a plastic material, preferably made of the same first plastic material as the base. Segments made of a plastic material are very inexpensive to manufacture and, in particular in conjunction with an end segment used to attach the handle, make it possible to manufacture the entire mop head essentially from a plastic material of the same or similar type, so that the recycling advantages already described above in connection with the mop head can also be achieved here.

For longer handles in particular, however, it may be necessary for reasons of stability not to manufacture at least some of the segments from a plastic material. In this case, those segments that are not made of a plastic material are preferably made of metal, preferably steel or light metal.

According to a further particularly preferred embodiment, it is provided that the spring clips are formed by integrated spring clips at least in those segments whose connection section is made of a plastic material and/or which are made entirely of a plastic material. Integrated spring clips can be produced particularly easily, especially in conjunction with a plastic material, for example, as previously explained, by cutting free and connecting a snap-in segment on one side.

In contrast, the spring clips that are not formed by integrated spring clips can each be formed by a separate component that is clipped into the hollow tapered end of the first segment, whereby the spring clip then has two spring legs that are elastically pretensioned in the direction of latching engagement, the free leg ends of which project in the latched state through openings on opposite sides of the tapered end of the first segment and further engage in correspondingly assigned openings on the hollow non-tapered end of the second segment.

It is advantageous, particularly for a lightweight structure or in connection with the simpler production of the detachable connection in the respective connection sections, if the segments are, at least with regard to the tapered end and/or the non-tapered end, hollow.

The end segment containing or building a hand grip can be provided with an elastic and resilient portion suitable for gripping by a user of the cleaning implement. In connection with such an embodiment, it is particularly advantageous if the end segment containing or building a hand grip is formed by two halves which are made of the same plastic material, preferably of the same plastic material as the base, and in the connected state enclose between them an end-side soft touch element made of a thermoplastic elastomer. The two halves can then preferably be joined together by plastic welding, in particular by ultrasonic welding. This again results in the previously described advantages of avoiding additional adhesives. This makes it very easy to recycle the end segment containing or building a hand grip, especially in the event that it is made entirely from a plastic material, preferably from the same first plastic material.

The above object is further solved by a method for producing a cleaning implement according to the first inventive cleaning implement solution as described above, the method comprising the following steps:
providing a base made of at least one first plastic material,
providing a pad made of at least one second plastic material which is suitable to be joined by plastic welding, preferably by thermal welding, to the at least one first plastic material of the base, and
joining of base and elastic pad to form a composite mop head by plastic welding, in particular by thermal welding.

The advantages resulting from this are identical to the advantages of the first inventive cleaning implement solution as described above. In this respect, to avoid repetition, reference is also made to the explanations given above.

In certain cases, the second plastic material selected for the pad cannot be joined to the base by thermal welding or plastic welding. This may be due, for example, to the material properties of the second plastic material, such as in the case of expanded polyethylene (EPE), which does not allow for reliable fusion bonding to the base.

In such cases, the above-mentioned object is further solved by a second inventive cleaning implement solution. The cleaning implement, especially a mop, containing a mop head having a base and a pad attached to the base, the mop head being adapted and configured to be provided with a cleaning sheet or a cleaning pad, wherein the base is made of at least one first plastic material, and wherein the pad is made of at least one second plastic material which is suitable to be joined to the at least one first plastic material of the base by adhesive bonding. The base and the pad are joined together by adhesive bonding to form a composite mop head.

In this context, the pad is adhesively bonded to the base, i.e., joined by means of a suitable adhesive layer forming a permanent mechanical connection between the mating surfaces of the base and the pad. The adhesive may be applied over the entire contact surface or selectively in predefined bonding zones, and may take the form of, for example, a pressure-sensitive adhesive (PSA), a hot-melt adhesive, or a reactive adhesive (e.g., polyurethane-based or epoxy-based). This approach allows for greater flexibility in material selection and enables the use of pad materials with advantageous functional properties (e.g., softness, elasticity, resilience) even when thermal bonding is not feasible. The use of adhesive bonding further simplifies the manufacturing process by avoiding thermal processing steps, and it may also enable modular assembly procedures where pad and base are joined in a final production stage.

Also with the second inventive cleaning implement solution, a particularly preferred embodiment is one in which the second plastic material has elastic properties and, accordingly, the pad is an elastic pad. The design of the pad as an elastic pad serves to ensure even pressure distribution and stability during cleaning work. It also supports the movement of the mop across the floor and ensures that the associated cleaning sheet or cleaning pad remains in effective contact with the surface to remove dirt.

In one embodiment, the first plastic material and the second plastic material are formed by different plastic materials. The use of two different plastic materials allows for a functional separation between the base and the pad, making it possible to tailor each component to its specific mechanical and functional requirements.

In a further embodiment, the first plastic material and the second plastic material are each thermoplastic plastic materials. The use of thermoplastic materials facilitates various manufacturing techniques, such as extrusion, injection molding, and thermoforming, allowing for efficient, scalable, and cost-effective production of the individual components. In addition, thermoplastics offer favorable recyclability and thermal processability, which supports environmentally conscious manufacturing practices and simplifies material handling in large-scale production environments.

According to a particularly preferred embodiment, the first plastic material is polypropylene (PP). Polypropylene (PP) offers a rigid and dimensionally stable base structure.

According to another particularly preferred embodiment, the second plastic material is expanded polyethylene (EPE). In particular, the selection of expanded polyethylene (EPE) for the pad enables the implementation of soft and resilient contact surfaces that are gentle on the floor while providing sufficient pressure for cleaning. Polypropylene (PP), on the other hand, offers a rigid and dimensionally stable base structure. Even though EPE cannot be thermally welded to PP, the implementation of adhesive bonding as a joining technique enables a reliable and permanent connection between the two components. This material combination results in a cost-effective and functionally optimized cleaning implement that ensures durability, ease of use, and effective dirt removal performance. The term “expanded” refers specifically to the fact that the polyethylene is expanded during the manufacturing process to create a foamed structure. This foamed structure consists of many small air bubbles trapped in the polyethylene, which gives the material the desired elastic properties. It is therefore able to deform and compress under load, but returns to its original shape when the load is removed.

Also with the second inventive cleaning implement solution, it is preferably provided that the base is formed plate-shaped with a base top surface and with a base bottom surface and/or that the pad is formed plate-shaped with a pad top surface and with a pad bottom surface. This makes it possible to construct a mop head that is particularly suitable for cleaning tasks. In addition, such geometries make it easy to connect the base to the pad. This also applies to a particularly preferred embodiment in which the mop head has a rectangular circumferential geometry.

Also with the second inventive cleaning implement solution, it is preferred that the mop head has a leading edge and a trailing edge. In connection with such a structure, it is further particularly preferred when the leading edge and the trailing edge of the mop head are formed as part of the pad, preferably in such a way that the pad is drawn around the respective associated base edge at the leading edge and at the trailing edge and is bonded to the base top surface by adhesive bonding. The term “leading edge” is intended to refer to the furthest edge of the mop head which leads the mop head when it is moved in a forward direction away from its user, whereas the term “trailing edge” is intended to refer to the furthest edge of the mop head which trails the mop head when it is moved in forward direction away from its user. For mops being used as floor mops, the leading edge and the trailing edge are substantially parallel to the longitudinal axis of the mop head, wherein the longitudinal axis is the axis along the length of the mop head.

Furthermore, it is particularly preferable if the base bottom surface is at least partially, preferably completely, covered by the pad and is at least partially bonded to the pad top surface by adhesive bonding. This not only results in a functionally reliable connection between the pad and the base, but also ensures that the entire underside of the mop head has elastic properties, especially in conjunction with an elastic pad.

Also with the second inventive cleaning implement solution, a design is preferred in which the pad bottom surface supports a cleaning sheet or a cleaning pad when it is attached to the mop head is also preferred. This allows cleaning tasks to be carried out safely and reliably, regardless of whether dry sheets or wet sheets are involved.

Also with the second inventive cleaning implement solution, it is preferred that for securing the cleaning sheet or cleaning pad to the mop head, it is particularly preferred if the base top surface contains at least one, preferably several, securing elements configured to receive and retain a cleaning sheet or cleaning pad about the mop head. It is particularly preferred if the at least one securing element is formed by a separate component which is detachably held, preferably contour-matched and/or surface-flush detachably held, in a receiving opening formed on the base top surface. Such a detachable holder has the advantage that the securing elements can be easily removed from the mop head, as they are not usually made of the same material as the rest of the mop head. This means that the securing elements can be disposed of and recycled separately.

Also with the second inventive cleaning implement solution, it is provided that the cleaning implement further contains a handle pivotably connected to the mop head, preferably connected to the mop head by means of a universal joint attached to the base top surface. The universal joint preferably comprises several, for example two, rotational axes that allow the handle to pivot in different directions. The pivotable linkage or, in particular, the universal joint results in the greatest possible freedom of movement of the mop head in different directions and angular positions. This makes it easier, for example, to maneuver the mop around corners and reach hard-to-reach areas more easily, which improves the overall cleaning performance.

In principle, the handle can be provided as a unitary structure. However, it is preferred when the handle contains at least two, preferably at least three, interconnectable segments that are detachably connected to each other in a connection section. This ensures that the cleaning implement can be shipped within a carton of convenience size and later assembled for use.

Irrespective of the specific number of segments, a particularly preferred embodiment provides that there are always two interconnectable segments defining a first segment and a second segment, the first segment having a tapered end which is configured to engage with a non-tapered end of the second segment, the first segment and the second segment being releasably connected in the joined state by means of a resilient spring clip. This allows the individual segments to be assembled and disassembled quickly and easily. The resilient spring clip enables simple and intuitive fixing, although it is of course also possible to connect the individual segments to each other in different ways, for example using threads so that the individual segments can be screwed together.

The above object is further solved by a method for producing a cleaning implement according to the second inventive cleaning implement solution as described above, the method containing the following steps:
providing a base made of at least one first plastic material,
providing a pad made of at least one second plastic material which is suitable to be joined by adhesive bonding to the at least one first plastic material of the base, and
joining of base and elastic pad to form a composite mop head by adhesive bonding.

The advantages resulting from this are identical to the advantages of the second inventive cleaning implement solution as described above. In this respect, to avoid repetition, reference is also made to the explanations given above.

The above-mentioned object is further solved by the following cleaning implement, especially a mop, containing:
a mop head having a base and a pad attached to the base, the mop head being adapted and configured to be provided with a cleaning sheet or a cleaning pad,
   a handle pivotably connected to the mop head, preferably connected to the mop head by means of a universal joint attached to the base top surface,
wherein the handle contains at least two, preferably at least three, interconnectable segments, which are detachably connected to each other in a connection section,
wherein two interconnectable segments define a first segment and a second segment, the first segment having a tapered end which is configured to engage with a non-tapered end of the second segment, the first segment and the second segment being releasably connected in the joined state by means of a resilient spring clip,
wherein the spring clip is an integral part of the, preferably hollow, connection section formed by a tapered end of a first segment, and
wherein the integrated spring clip is formed by a snap-in segment, preferably by a snap-in segment cut free in the region of the tapered end and/or connected on one side, which is elastically resiliently pretensioned in the direction of latching engagement, so that in the latched state it engages overpressably in a correspondingly assigned opening at the hollow non-tapered end of an assigned second segment.

As already explained in detail in connection with the first and second inventive cleaning implement solutions, in particular the first inventive cleaning implement solution, the advantage of such an integrated spring clip is that it can reduce the variety of components, which in turn has a beneficial effect on the manufacturing and assembly costs.

The advantages resulting from the related subclaims have already been explained in detail in connection with the discussion of the first and second inventive cleaning implement solutions, in particular the first inventive cleaning implement solution. In this respect, reference is again made here to the previously made explanations in order to avoid repetition.

Other features which are considered as characteristic for the invention are set forth in the appended claims.

Although the invention is illustrated and described herein as embodied in a cleaning implement, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

The invention is explained in more detail below by way of example only.

### BRIEF DESCRIPTION OF THE FIGURES

FIG. 1 is a diagrammatic, perspective view of an exemplary cleaning implement according to the invention;

FIG. 2A is a schematic, and perspective detailed view of the mop head of FIG. 1;

FIG. 2B is an enlarged, perspective view of detail IIB shown in FIG. 2A in connection with a further metal segment to be connected;

FIG. 2C is an illustration showing a segment of FIG. 2B in the assembled state;

FIG. 3 is an illustration showing two metal segments to be connected to each other with a spring clip formed by a separate component;

FIG. 4 is a perspective view of an end segment containing a hand grip formed by two halves; and

FIGS. 5A and 5B are perspective view showing the mop head before removing the securing elements, see FIG. 5A, and in FIG. 5B the mop head after removing the securing elements.

### DETAILED DESCRIPTION OF THE INVENTION

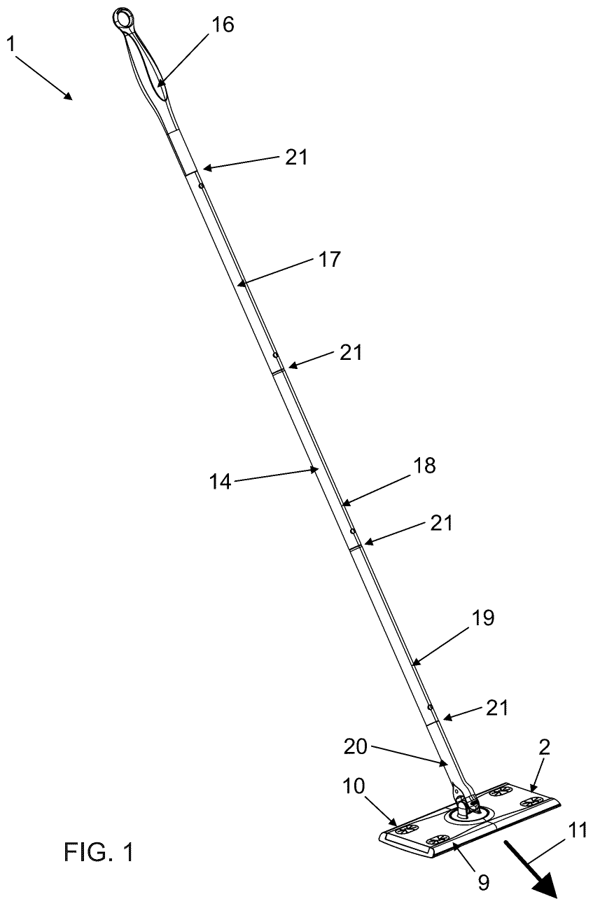

Referring now to the figures of the drawings in detail and first, particularly to FIG. 1 thereof, there is shown an exemplary perspective view of a cleaning implement 1 according to the invention, which is formed here by a mop respectively a floor mop.

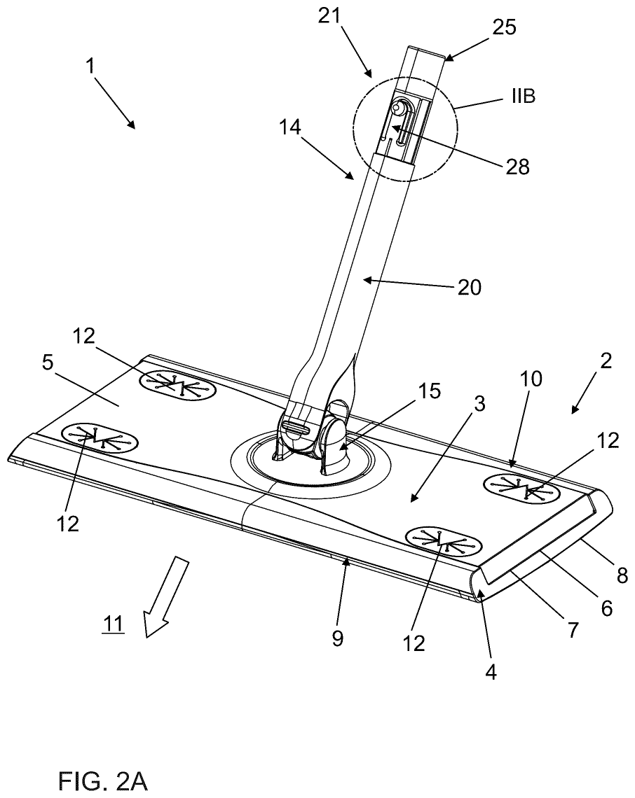

The mop has a mop head 2 which, as can be seen in particular from FIG. 2A, has a base 3 and a pad 4, which is designed here as an elastic pad and is firmly connected to the base. The mop head 2 is adapted and configured to be provided with a cleaning sheet or a cleaning pad (not shown).

The mop head 2 has an essentially rectangular circumferential geometry, whereby the base 3 is plate-shaped with a base top surface 5 and a base bottom surface 6. The elastic pad 4 is also plate-shaped with a pad top surface 7 and a pad bottom surface 8.

As can be seen in FIG. 2A in particular, the mop head 2 has a leading edge 9 and a trailing edge 10.

The leading edge 9 and the trailing edge 10 are formed as part of the elastic pad 4, in the example shown here in such a way that the elastic pad 4 is pulled around the respective assigned base edge at the leading edge 9 and at the trailing edge 10 and is firmly attached to the base top surface 5. The leading edge 9 refers to the furthest edge of the mop head 2 which leads the mop head 2 when it is moved in a forward direction 11 away from its user, whereas the trailing edge 10 refers to the furthest edge of the mop head 2 which trails the mop head 2 when it is moved in a forward direction 11 away from its user.

In the example shown here, the base bottom surface 6 is completely covered by the elastic pad 4 and is also firmly connected to the pad top surface 7, at least in some areas.

The base is made of polypropylene (PP), while the elastic pad 4 is made of expanded polypropylene (EPP). The elastic pad 4 made of EPP therefore has a foamed structure, which gives the elastic pad 4 the desired elastic properties.

The elastic pad 4 and the base 3 are thermally welded together to form a strong bond, so that no additional adhesive layer or adhesive is required or present between the base 3 and the elastic pad 4. As a result, the base 3 and the elastic pad 4 form a mop head 2, which is essentially a single material composite that can be easily recycled.

In an alternative embodiment, the elastic pad 4 may also be made of expanded polyethylene (EPE), which likewise has a foamed structure but cannot be reliably joined to the base 3 by thermal welding. In such cases, the elastic pad 4 is adhesively bonded to the base 3, for example using a pressure-sensitive adhesive (PSA) or a hot-melt adhesive, to form a strong and permanent mechanical connection. This embodiment enables greater flexibility in material selection and is particularly suitable when thermal joining is not feasible due to the material properties of the pad.

As can also be seen from the combination of FIG. 1 and FIG. 2A, the base top surface 5 has several securing elements 12 arranged essentially at the corners, which are suitable and designed to hold a cleaning sheet or a cleaning pad on the mop head 2, but this is not shown here.

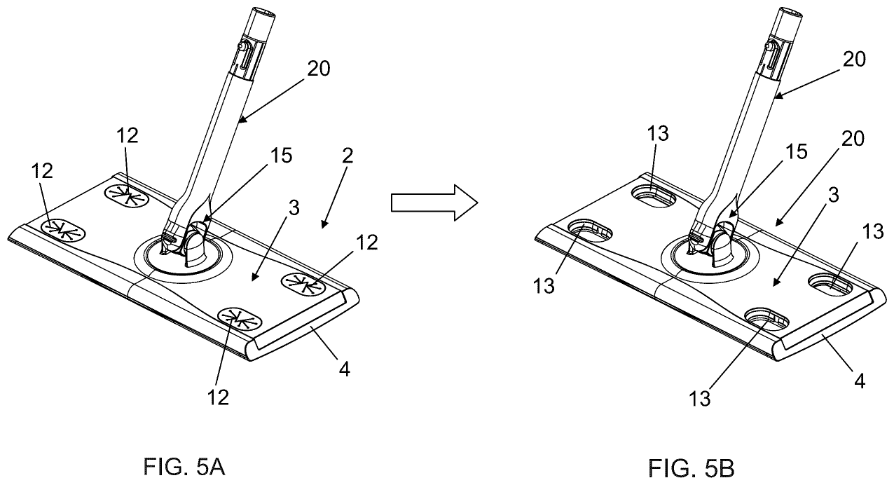

As can be seen in particular from FIGS. 5A and 5B, the securing elements 12 can be formed by separate components which are detachably held in a receiving opening 13 formed on the base top surface 5 in a contour-adapted and surface-flush manner. This allows the securing elements 12 to be removed from the mop head 2, as shown in FIG. 5B, so that the mop head 2 can then be recycled.

As can also be seen from FIGS. 1, 2A and 5, the cleaning implement 1 also has a handle 14, which is pivotably articulated to the base top surface 5 in several spatial directions by means of a universal joint 15.

The handle 14 here has several interconnectable segments 16 to 20, which are detachably connected to each other in a connection section 21 in a manner yet to be described.

Specifically, the segment 20 forms an end segment used to attach the handle to the mop head 2, which in the example shown here is made entirely of a plastic material, preferably made of the same plastic material as the base 3, namely polypropylene (PP).

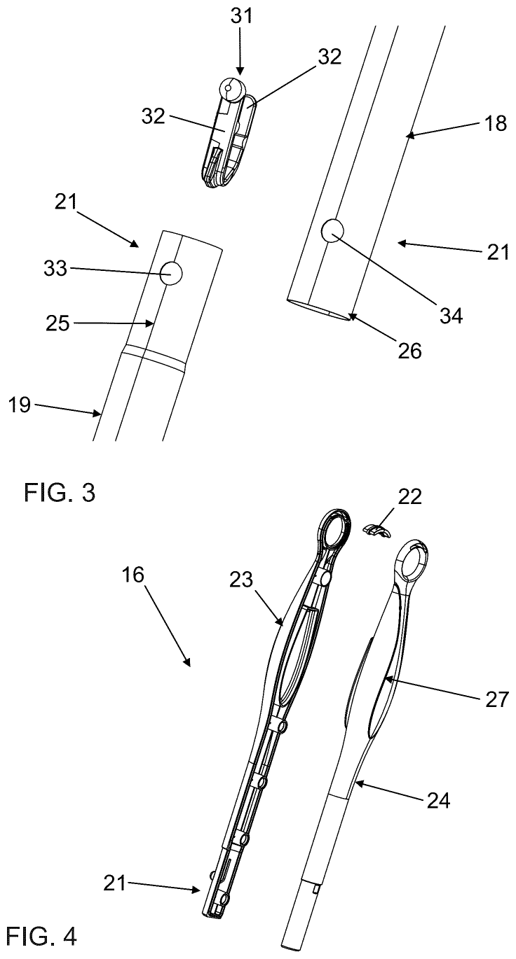

The segment 16 opposite the segment 20 also forms an end segment, which in this example is formed by two halves 23, 24 (see FIG. 4), which are preferably made of the same plastic material as the base 3, namely polypropylene (PP). When connected, the two halves 23, 24 enclose an end soft touch element 22 between them. The two halves 23, 24 are also joined together by plastic welding, preferably by ultrasonic welding.

In the example shown here, the segments 17, 18 and 19 located between the end segment 16 and the end segment 20 are made of metal, for example steel.

Since the universal joint 15 and the segment 20 are also made of the same plastic material, namely polypropylene (PP) in the example shown here, the entire mop head 2 together with the universal joint 15 and segment 20 can be easily recycled, as shown in FIG. 5B, without the need for further time-consuming cleaning work and separation measures.

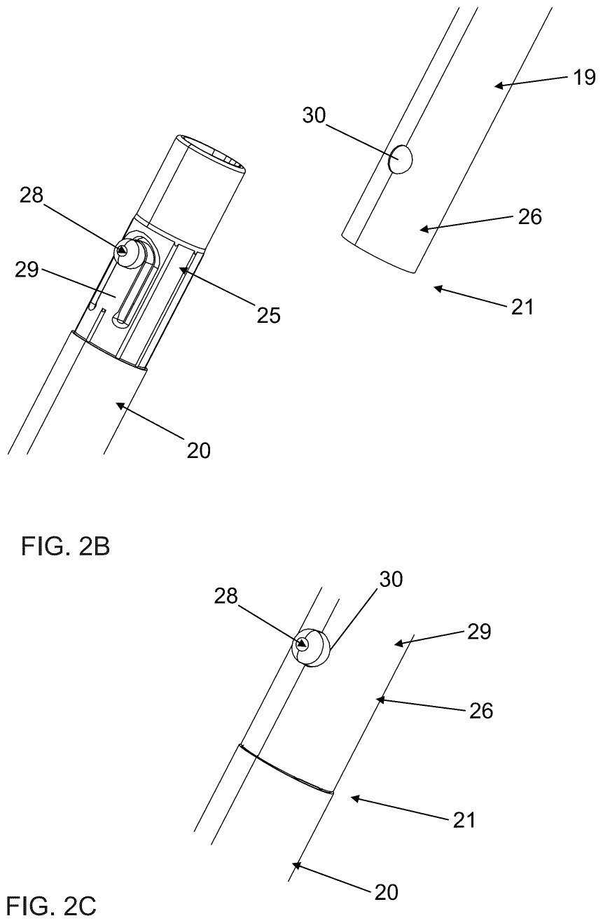

In the embodiment shown here, two interconnectable segments always form a first segment and a second segment, the first segment having a tapered end 25 (see in particular FIGS. 2A, 2B and 3) which is configured to engage with a non-tapered end 26 of the second segment, the first segment and the second segment being releasably connected in the joined state by means of a resilient spring clip.

In the example shown here, the two segments 18, 19 formed by metal each have a tapered end 25 and a non-tapered end 26, while the segment 17 formed by metal has two non-tapered ends 26. Consequently, the end segment 20 used to attach the handle 14 to the mop head 2 and the end segment 16 containing a hand grip 27 have a tapered end 25 so as to interconnect with the segments 17 respectively 19.

As can be seen in particular from the combined view of FIGS. 2A, 2B and 2C, whereby FIG. 2B shows an enlarged detail A of FIG. 2A, the spring clip 28 is here an integral component of the connection section 21 formed by a tapered end 25 and preferably hollow. Specifically, the integrated spring clip 28 is formed by a snap-in segment 29 cut free in the area of the tapered end 25 and connected on one side, which, as shown in FIG. 2C, is elastically resiliently pretensioned in the direction of latching engagement so that in the latched state it engages overpressably in a correspondingly assigned opening 30 on the hollow non-tapered end 26 of the assigned segment 19.

As can also be seen from FIG. 3, and here as an example for the segments 18 and 19 formed from metal, spring clips 31 can be provided to connect them, which are each formed here by a separate component. Specifically, the spring clips 31 are clipped into the hollow tapered end 25 of segment 19, whereby the spring clip 31 has two spring legs 32 that are elastically pretensioned in the direction of latching engagement, the free leg ends 32 of which project in the latched state through openings 33 on opposite sides of the tapered end 25 of segment 19 and also engage in correspondingly assigned openings 34 on the hollow non-tapered end 26 of segment 18.

As can also be seen from the figures, the individual segments are preferably hollow, at least in relation to the tapered end 25 or the non-tapered end 26.

The following is a summary list of reference numerals and the corresponding structure used in the above description of the invention:
1 cleaning implement
2 mop head
3 base
4 pad/elastic pad
5 base top surface
6 base bottom surface
7 pad top surface
8 pad bottom surface
9 leading edge
10 trailing edge
11 forward direction
12 securing element
13 receiving opening
14 handle
15 universal joint
16 segment
17 segment
18 segment
19 segment
20 segment
21 connection section
22 soft touch element
23 half
24 half
25 tapered end
26 non-tapered end
27 hand grip
28 spring clip
29 snap-in segment
30 opening
31 spring clip
32 spring leg
33 opening
34 opening

1. A cleaning implement, comprising:
a mop head having a base and a pad attached to said base, said mop head adapted and configured to receive a cleaning sheet or a cleaning pad, wherein:
said base is made of at least one first plastic material;
said pad is made of at least one second plastic material which is suitable to be joined by plastic welding to said at least one first plastic material of said base; and
said base and said pad are joined together by said plastic welding and form a composite mop head.

2. The cleaning implement according to claim 1, wherein:
said at least one second plastic material has elastic properties; and
said pad is an elastic pad.

3. The cleaning implement according to claim 1, wherein said at least one first plastic material and said at least one second plastic material are formed by different plastic materials.

4. The cleaning implement according to claim 3, wherein said at least one first plastic material and said at least one second plastic material are each thermoplastic plastic materials.

5. The cleaning implement according to claim 1, wherein said at least one first plastic material is polypropylene (PP).

6. The cleaning implement according to claim 1, wherein said at least one second plastic material is expanded polypropylene (EPP).

7. The cleaning implement according to claim 1, wherein:
said base is formed plate-shaped with a base top surface and with a base bottom surface; and/or
said pad is formed plate-shaped with a pad top surface and with a pad bottom surface.

8. The cleaning implement according to claim 1, wherein said mop head has a rectangular circumferential geometry.

9. The cleaning implement according to claim 7, wherein:
said mop head has a leading edge and a trailing edge; and
said leading edge and said trailing edge of said mop head are formed as a part of said pad.

10. The cleaning implement according to claim 7, wherein said base bottom surface is at least partially covered by said pad and is at least partially plastic-welded to said pad top surface.

11. The cleaning implement according to claim 7, wherein said pad bottom surface supports the cleaning sheet or the cleaning pad when it is attached to said mop head.

12. The cleaning implement according to claim 7, wherein said base top surface contains at least one securing element configured to receive and retain the cleaning sheet or the cleaning pad about said mop head.

13. The cleaning implement according to claim 12, wherein said base top surface has a receiving opening formed therein, said at least one securing element is formed by a separate component which is releasably held in said receiving opening.

14. The cleaning implement according to claim 1, further comprising a handle pivotably connected to said mop head.

15. The cleaning implement according to claim 14, wherein said handle contains at least two interconnectable segments which are detachably connected to each other in a connection section.

16. The cleaning implement according to claim 15,
wherein said at least two interconnectable segments define a first segment and a second segment, said first segment has a tapered end which is configured to engage with a non-tapered end of said second segment; and
further comprising a resilient spring clip, said first segment and said second segment are releasably connected in a joined state by means of said resilient spring clip.

17. The cleaning implement according to claim 16, wherein said at least two interconnectable segments are two of a plurality of segments, said segments found in a middle of said handle contain a tapered end and a non-tapered end, and wherein an end segment of said segments used to attach said handle to said mop head and an end segment of said segments containing a hand grip have at least a tapered end or a non-tapered end so as to interconnect with said segments in said middle of said handle.

18. The cleaning implement according to claim 16, wherein:
said non-tapered end of said second segment has an opening formed therein;
said resilient spring clip is an integral part of said connection section formed by said tapered end of said first segment; and
said resilient spring clip is formed as a snap-in segment which is elastically resiliently pretensioned in a direction of latching engagement, so that in a latched state said resilient spring clip engages overpressably in a correspondingly assigned said opening formed in said non-tapered end of said second segment.

19. The cleaning implement according to claim 16, wherein at least part of said at least two interconnectable segments at least in said connection section to an adjoining section is made from a plastic material.

20. The cleaning implement according to claim 19, wherein a part of said at least two interconnectable segments which are not made of any said plastic material are made of metal.

21. The cleaning implement according to claim 19, wherein said resilient spring clip is one of a plurality of resilient spring clips, some of said resilient spring clips are formed as integrated spring clips at least in said segments whose said connection section is made of said plastic material and/or which are made entirely of said plastic material.

22. The cleaning implement according to claim 21, wherein:
said tapered end of said first segment has on opposite sides of said tapered end openings formed therein;
said non-tapered end of said second segment has openings formed therein; and
said resilient spring clips which are not formed as said integrated spring clips are each formed by a separate component which is clipped into said tapered end, being a hollowed tapered end, of said first segment, said resilient spring clips each have two spring legs which are elastically prestressed in a direction of latching engagement and whose free leg ends in a latched state project through said openings on said opposite sides of said tapered end of said first segment and further engage in correspondingly associated said openings on said non-tapered end of said second segment.

23. The cleaning implement according to claim 16, wherein said segments are, at least with regard to said tapered end and/or said non-tapered end, are hollow.

24. The cleaning implement according to claim 16, wherein an end segment of said at least two interconnectable segment contains or builds a hand grip is formed by two halves which are made of a same plastic material, and in a joined state enclose between them an end-side soft touch element made of a thermoplastic elastomer.

25. A method for producing a cleaning implement, which comprises the steps of:
providing a base made of at least one first plastic material,
providing a pad made of at least one second plastic material which is suitable to be joined by plastic welding to the at least one first plastic material of the base; and
joining the base and the pad to form a composite mop head by said plastic welding.

26. A cleaning implement, comprising:
a mop head having a base and a pad attached to said base, said mop head adapted and configured to receive a cleaning sheet or a cleaning pad, wherein:
said base is made of at least one first plastic material;
said pad is made of at least one second plastic material suitable to be joined to said at least one first plastic material of said base by adhesive bonding; and
said base and said pad are joined together by said adhesive bonding to form a composite mop head.

27. The cleaning implement according to claim 26, wherein said at least one second plastic material has elastic properties and accordingly said pad is an elastic pad.

28. The cleaning implement according to claim 26, wherein said at least one first plastic material and said at least one second plastic material are formed from different plastic materials.

29. The cleaning implement according to claim 28, wherein said at least one first plastic material and said at least one second plastic material are each thermoplastic plastic materials.

30. The cleaning implement according to claim 26, wherein said at least one first plastic material is polypropylene (PP).

31. The cleaning implement according to claim 26, wherein said at least one second plastic material is expanded polyethylene (EPE).

32. The cleaning implement according to claim 26, wherein:
said base is formed plate-shaped with a base top surface and with a base bottom surface; and/or
said pad is formed plate-shaped with a pad top surface and with a pad bottom surface.

33. The cleaning implement according to claim 26, wherein said mop head has a rectangular circumferential geometry.

34. The cleaning implement according to claim 32, wherein:
said mop head has a leading edge and a trailing edge; and
said leading edge and said trailing edge of said mop head are formed as a part of said pad.

35. The cleaning implement according to claim 32 wherein said base bottom surface is at least partially covered by said pad and is at least partially bonded to said pad top surface by adhesive bonding.

36. The cleaning implement according to claim 32, wherein said pad bottom surface supports the cleaning sheet or the cleaning pad when said pad bottom surface is attached to the mop head.

37. The cleaning implement according to claim 32, wherein said base top surface contains at least one securing element configured to receive and retain the cleaning sheet or the cleaning pad about said mop head.

38. The cleaning implement according to claim 37, wherein said base top surface has a receiving opening formed therein, said at least one securing element is formed by a separate component which is releasably held in said receiving opening.

39. The cleaning implement according to claim 26, further comprising a handle (14) pivotably connected to said mop head.

40. The cleaning implement according to claim 39, wherein said handle has at least two interconnectable segments which are detachably connected to each other in a connection section.

41. The cleaning implement according to claim 40,
further comprising a resilient spring clip; and
wherein said at least two interconnectable segments include a first segment and a second segment, said first segment has a tapered end which is configured to engage with a non-tapered end of said second segment, said first segment and said second segment are releasably connected in a joined state by means of said resilient spring clip.

42. A method for producing a cleaning implement, which comprises the steps of:
providing a base made from at least one first plastic material;
providing a pad made from at least one second plastic material which is suitable to be joined by plastic welding to the at least one first plastic material of the base; and
joining the base and the pad to form a composite mop head by adhesive bonding.

43. A cleaning implement, comprising:
a mop head having a base and a pad attached to said base, said mop head adapted and configured to receive a cleaning sheet or a cleaning pad;
a resilient spring clip;
a handle pivotably connected to said mop head, said handle containing at least two interconnectable segments detachably connected to each other in a connection section, said at least two interconnectable segments define a first segment and a second segment, said first segment having a tapered end configured to engage with a non-tapered end of said second segment, said first segment and said second segment being releasably connected in a joined state by means of said resilient spring clip, said non-tapered end of said second segment having an opening formed therein;
said resilient spring clip is an integral part of said connection section formed by said tapered end of said first segment; and
said resilient spring clip is formed by a snap-in segment which is elastically resiliently pretensioned in a direction of latching engagement, so that in a latched state said snap-in segment engages overpressably in a correspondingly assigned said opening at said non-tapered end of an assigned said second segment.

44. The cleaning implement according to claim 43, wherein at least part of said at least two interconnectable segments at least in said connection section to an adjoining segment is made of a plastic material.

45. The cleaning implement according to claim 44, wherein those segments or parts of said segments of said at least two interconnectable segments which are not made of said plastic material are made of metal.

46. The cleaning implement according to claim 43, wherein said resilient spring clip is one of a plurality of spring clips, said spring clips are formed as integrated spring clips at least in those of said at least two interconnectable segments whose connection section is made of said plastic material and/or which are made entirely of said plastic material.

47. The cleaning implement according to claim 46, wherein:
said tapered end of said first segment has on opposite sides of said tapered end openings formed therein;
said non-tapered end of said second segment has openings formed therein; and
said spring clips which are not formed as said integrated spring clips are each formed by a separate component which is clipped into said tapered end of said first segment, said spring clips each having two spring legs which are elastically prestressed in the direction of latching engagement and whose free leg ends in the latched state project through said openings on said opposite sides of said tapered end of said first segment and further engage in correspondingly associated said openings on said non-tapered end of said second segment.

48. The cleaning implement according to claim 43, wherein said at least two interconnectable segments are two of a plurality of segments, said segments found in a middle of said handle contain said tapered end and said non-tapered end, and wherein an end segment of said segments is used to attach said handle to said mop head and said end segment forming a hand grip having at least a tapered or non-tapered end so as to interconnect with said segments in said middle of said handle.

49. The cleaning implement according to claim 43, wherein said at least two interconnectable segments are, at least with regard to said tapered end and/or said non-tapered end, hollow.

50. The cleaning implement according to claim 43, wherein an end segment of said at least two interconnectable segments forms a hand grip and is formed by two halves which are made of a same plastic material, and in a joined state enclose between them an end-side soft touch element made of a thermoplastic elastomer.

51. The cleaning implement according to claim 43, wherein:
said base is made of at least one first plastic material;
said pad is made of at least one second plastic material which is suitable to be joined to said at least one first plastic material of said base by plastic welding; and
said base and said pad are joined together by plastic welding to form a composite mop head.

52. The cleaning implement according to claim 43, wherein:
said base is made of at least one first plastic material;
said pad is made of at least one second plastic material which is suitable to be joined to said at least one first plastic material of said base by adhesive bonding; and
said base and said pad are joined together by adhesive bonding to form a composite mop head.
